(19) United States
(12) Patent Application Publication
(10) Pub. No.: US 2023/0334378 A1
(43) Pub. Date: Oct. 19, 2023

(54) FEATURE EVALUATIONS FOR MACHINE LEARNING MODELS

(71) Applicant: PAYPAL, INC., San Jose, CA (US)

(72) Inventors: Adam Inzelberg, Tel Aviv (IL); Oria Domb, Tel Aviv (IL)

(21) Appl. No.: 17/721,761

(22) Filed: Apr. 15, 2022

(51) Int. Cl. G06N 20/20; G06F 11/34

(52) U.S. Cl. CPC G06N 20/20; G06F 11/3495

(57) ABSTRACT

Methods and systems are presented for evaluating the effects of different input features on a machine learning model. The machine learning model is configured to perform a task based on a first set of features. When a second set of features becomes available for performing the task, an evaluation model is generated for evaluating the effect of including the second set of features as input features for the machine learning model to perform the task. The evaluation model is configured to accept inputs corresponding to an output from the machine learning model and the second set of features. The performance in performing the task by the evaluation model is determined and compared against the performance of the machine learning model. Based on a performance gain of the evaluation model over the machine learning model, the machine learning model is modified to incorporate the second set of features as input features.

### BACKGROUND

The present specification generally relates to machine learning models, and more specifically, to a framework for evaluating features of a machine learning model according to various embodiments of the disclosure.

### RELATED ART

Machine learning models have been widely used to perform various tasks for different reasons. For example, machine learning models may be used in classifying data (e.g., determining whether a transaction is a legitimate transaction or a fraudulent transaction, determining whether a merchant is a high-value merchant or not, determining whether a user is a high-risk user or not, etc.). To construct a machine learning model, a set of input features that are related to performing a task associated with the machine learning model are identified. Training data that includes attribute values corresponding to the set of input features and labels corresponding to pre-determined prediction outcomes may be provided to train the machine learning model. Based on the training data and labels, the machine learning model may learn patterns associated with the training data, and provide predictions based on the learned patterns. For example, new data (e.g., transaction data associated with a new transaction) that corresponds to the set of input features may be provided to the machine learning model. The machine learning model may perform a prediction for the new data based on the learned patterns from the training data.

While machine learning models are effective in learning patterns and making predictions, conventional machine learning models are typically inflexible regarding the input features used to perform the tasks once they are configured and trained. In other words, once a machine learning model is configured and trained to perform a task (e.g., a classification, a prediction, etc.) based on the set of input features, it is often difficult (and computer resources intensive) to modify the set of input features (e.g., adding new input features, removing input features, etc.) used to perform the task or accurately predict an outcome. For example, in order to modify the input features of a machine learning model, the machine learning model has to be re-constructed and undergo extensive re-training using new training data that corresponds to the modified set of input features.

It has been contemplated that after a machine learning model has been constructed and trained for performing a task, new features (that are not included as the input features of the machine learning model) may become available for performing the task. Without a framework that efficiently and effectively evaluates the new features, an organization may either reject the new features due to the cost to incorporate the new features into the machine learning model resulting in accurate predictions or may commit to spending the resources to modify the machine learning model without knowing how the new features affect the performance of the machine learning model. As such, there is a need for providing a framework that can efficiently and effectively evaluate how different features affect the performance of a machine learning model.

### BRIEF DESCRIPTION OF THE FIGURES

FIG. 1 is a block diagram illustrating an electronic transaction system according to an embodiment of the present disclosure;

FIG. 2 illustrates different sets of input features available for machine learning models to perform their respective tasks according to an embodiment of the present disclosure;

FIG. 3A illustrates an example evaluation model for evaluating a set of features usable by a machine learning model to perform a task according to an embodiment of the present disclosure;

FIG. 3B illustrates another example evaluation model for evaluating a set of features usable by a machine learning model to perform a task according to an embodiment of the present disclosure;

FIG. 4 illustrates example encoders used to generate input values for an evaluation model according to an embodiment of the present disclosure;

FIG. 5 is a flowchart showing a process of evaluating a set of features usable by a machine learning model to perform a task according to an embodiment of the present disclosure;

FIG. 6 is a flowchart showing a process of comparing different sets of features usable by a machine learning model to perform a task according to an embodiment of the present disclosure;

FIG. 7 illustrates an example neural network that can be used to implement a machine learning model according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for evaluating the effects of different input features on a machine learning model. An organization may configure and train a machine learning model to perform a particular task. Consider an example where the organization provides electronic payment services, the organization may configure one or more machine learning models to assist in processing electronic payment transactions. The tasks performed by these machine learning models (also referred to as “transaction models”) may be related to classifying a user (e.g., classifying a user as a high-risk user or a low-risk user, etc.) or classifying an electronic payment transaction (e.g., classifying a transaction as a high-risk transaction or a low-risk transaction, etc.). In order to configure the transaction models, the organization may initially determine a first set of features that is available to the organization and that is relevant in performing the task as input features for the transaction models. When the task is related to classifying an electronic payment transaction, the first set of features may include features such as an amount of the transaction, a location of a user who initiated the transaction, device attributes of a device used to initiate the transaction, a transaction history of the user, and other features.

As discussed herein, after the transaction model has been configured and trained, new features that are relevant in performing the task may become available to the organization. For example, the organization may have access to a new data source (e.g., a third-party website analytic agency that provides attributes of a merchant website, a third-party company analytics provider, etc.) or may consider acquiring new features from the new data source. The organization may determine whether to incorporate the new features (e.g., a second set of features) into the machine learning model. However, incorporating new features into a machine learning model can require a substantial amount of computer resources and can also take a substantial amount of time. For example, the internal structure of the machine learning model may have to be modified, and the modified machine learning model has to be re-trained using new training data. Furthermore, access to the second set of features may also be associated with a cost (e.g., a subscription fee or a one-time fee that the organization has to pay to a third-party provider). Thus, the organization may desire to evaluate the second set of features (for performing the task (e.g., how much improvements the new features provide to the transaction model in performing the task)) before committing to paying the cost and spending the resources to modify the transaction model.

Conventionally, in order to evaluate the effects of the new features (i.e., the second set of features) in performing the task, the organization may generate a new machine learning model based on modifying the transaction model. The new machine learning model may be configured to use the first set of features associated with the existing transaction model and the second set of features (i.e., the new features) to perform the task. The organization may train the new machine learning model, and may use the new machine learning model to perform the task in conjunction with the existing transaction model. The organization may then compare the results from the two models to determine whether the addition of the second set of features provides any improvements to the performance of the task (e.g., whether the results from the new machine learning model are improved, e.g., more accurate, over the results from the existing transaction model). However, as discussed herein, modifying the existing transaction model to accept all of the features (e.g., including the first and second sets of features) and re-training the new machine learning model require a substantial amount of computer resources and time. For example, it may also take several hours or even several days to re-train the machine learning model. As such, evaluating the new features in this manner can be expansive in terms of time and computer resources. Furthermore, due to cost and time required to evaluate the new features, the organization may opt to make a decision (e.g., commit to the new data source or decline the new data source) without knowing the benefits (or lack thereof) that the new features may provide in performing the task.

As such, according to various embodiments of the disclosure, a feature evaluation system may evaluate features (i.e., new features) for a machine learning model based on an evaluation model that combines the output of the existing machine learning model with the new features as input features for the performing the task. Specifically, instead of building a new machine learning model that is configured to receive both the first and second sets of features as input features for performing the task, the feature evaluation system leverages the existing machine learning model for evaluating the new features. Such an approach for evaluating the new features is beneficial as it substantially reduces the amount of computing resources and time for evaluating the new features such that a decision to incorporate the new features can be made quickly and efficiently.

In some embodiments, the feature evaluation system may implement the evaluation model using a machine learning model framework that has a simpler structure than the one used to implement existing machine learning models (e.g., the transaction model). For example, when the transaction model is implemented using an artificial neural network, the evaluation model can be implemented using a gradient boosting tree. While the artificial neural network provides a higher level of accuracy prediction in performing the task due to its more advanced and complex internal structure for analyzing data, the gradient boosting tree provides simpler and faster implementation and training, which further reduces the time and resources for evaluating the new features. Furthermore, since the evaluation model is only used for estimating the performance of the new features, rather than processing real-world transactions (e.g., used to classify transactions for actual processing of the transactions, etc.), the loss of accuracy performance based on the use of the simpler machine learning model structure can be justified. When a decision to incorporate the new features is made after evaluating the new features, the organization may then spend the cost and other resources for fully modifying the transaction model to incorporate the new features into the performance of the task using the advanced machine learning model structure.

As discussed herein, the existing transaction model may be configured to perform the task based on the first set of features available to the organization. In the example where the transaction model is used to classify a transaction (e.g., determining whether a transaction is a fraudulent transaction or a legitimate transaction, etc.), the transaction model may accept values corresponding to the first set of features as inputs, and may produce an output (e.g., a risk score) that indicates whether the transaction is a fraudulent transaction or a legitimate transaction. Since the output of the transaction model is generated based on the first set of features through the internal structure and algorithms associated with the transaction model, the output of the transaction model may accurately represent how the first set of features affect the performance of the task.

As such, instead of configuring the evaluation model to accept the first set of features associated with the existing transaction model as part of the input features, the feature evaluation system may substitute the first set of features with the output from the transaction model as part of the input features for the evaluation model. Thus, the feature evaluation system may configure the evaluation model to receive (i) an output from the transaction model and (ii) the second set of features (i.e., the new features) as the input features for performing the task. Using the combination of the output from the transaction model and the second set of features for performing the task, the evaluation model may mimic the performance of a model that performs the task based on the first and second sets of features (e.g., the model generated under the conventional approach).

In some embodiments, the feature evaluation system may also generate training data for training the evaluation model. Each training data set may include values that correspond to an output of the transaction model (e.g., an actual output from the transaction model based on data corresponding to the first set of features and associated with a transaction) and values that correspond to the second set features (e.g., actual attributes associated with the transaction provided by the new data source). For example, the organization may have access to the new data source for a short duration (e.g., as a trial period), where the organization may obtain data attributes corresponding to the second set of features and associated with actual transactions being processed by the organization. The organization may use the transaction model to generate an output for the transaction (e.g., using data corresponding to the first set of features). The feature evaluation system may then store the output from the machine learning model and the data attributes corresponding to the second set of features as a training data record. The feature evaluation system may train the evaluation model using the training data.

After training the evaluation model, the feature evaluation system may use the evaluation model to perform the task for new incoming transactions. For example, the feature evaluation system may obtain an output from the transaction model (e.g., a first risk score) based on the transaction model performing the task in connection with processing a transaction. The feature evaluation system may also obtain, for the transaction, data values corresponding to the second set of features from the new data source. The feature evaluation system may then feed the first risk score generated by the transaction model and the data values corresponding to the second set of features to the evaluation model. Since the evaluation model is configured to perform the task based on the output from the transaction model and the second set of features, the evaluation model may produce another output (e.g., a second risk score) based on the first risk score and the data values.

The feature evaluation model may then compare the first risk score and the second risk score against an actual result from processing the transaction. For example, the feature evaluation model may obtain an actual result associated with processing the transaction (e.g., whether the transaction has been found to be a fraudulent transaction or not). The feature evaluation model may then determine whether the second risk score provides a more accurate prediction (e.g., risk indication) for the transaction. In some embodiments, the feature evaluation model may evaluate the second set of features over multiple transactions (e.g., transactions conducted over a period of time such as a day a week, etc.). As such, the feature evaluation model may accumulate the results produced by both the transaction model and the evaluation model. The feature evaluation model may then determine performance metrics for each of the models by comparing the results produced by the models against the actual results from processing the transactions. For example, the feature evaluation model may determine a false positive rate, a false negative rate, a catch count, and/or other metrics for quantifying the prediction performance of the models. The feature evaluation model may then compare the performance metrics between the transaction model and the evaluation model. In some embodiments, the performance metrics may be calculated based on a business impact (e.g., a monetary cost saving, etc.) based on the increased accuracy performance of the feature evaluation model over the transaction model. The difference between the performance metrics of the transaction model and the evaluation model may be interpreted as the improvements in performing the task based on the incorporation of the new features.

In some embodiments, the feature evaluation system may determine a benchmark improvement, such that the feature evaluation system would incorporate the new features into the machine learning model if the inclusion of the new features improves the performance of the task over the existing transaction model by the benchmark improvement. As such, the feature evaluation system may determine whether the improvements in performing the task based on the inclusion of the new features meet and/or exceed the benchmark improvement. If the improvements meet or exceed the benchmark improvement, the feature evaluation system may modify the transaction model by incorporating the new features into the transaction model. On the other hand, if the improvements do not meet the benchmark improvement, the feature evaluation system may determine not to incorporate the new features into the transaction model, thus saving the organization a substantial amount of money and computer resources.

In some embodiments, in addition to evaluating the effect of different features in performing a task, the feature evaluation system may also compare the effects of different sets of features (e.g., features from different data sources) in performing the task. Consider an example where multiple new data sources may become available to the organization. The multiple new data sources may provide features that are similar in nature. For example, each of the multiple new data sources may provide data associated with website intelligence analytics. The new data sources may provide the same or different types of data that may be in the same or different formats. For example, a first data source may provide an average number of visitors per day on a website, while a second data source may provide an average session duration for the website. In another example, the first data source may provide a number of payment options offered by the website, while the second data source may provide an order of the payment options that appear on the website.

The organization may wish to compare the performance of the different features provided by the different data sources, such that the organization may select one of the different data sources to use for performing the task. As such, the feature evaluation system may use the techniques disclosed herein to generate different evaluation models corresponding to the different data sources to assess the performance of the features from each of the different data sources. In some embodiments, since the different data sources provide different types of data or data in different formats, the feature evaluation system may normalize the data, and may feed the normalized data to the evaluation models. For example, the feature evaluation system may generate an encoder for each of the data sources. The encoder may be configured to encode the features corresponding to the data source into a set of representations within a multi-dimensional space. The representations may be implemented as a vector within the multi-dimensional space. In some embodiments, each of the encoders may be configured to encode the different features from the corresponding data sources into vectors within the same multi-dimensional space.

The feature evaluation system may generate training data for the evaluation model using the same techniques disclosed herein, and may train the evaluation model. After training the evaluation model, the feature evaluation system may use the evaluation model to evaluate the performance of different features from the different data sources. For example, the feature evaluation system may determine performance metrics for each data source based on the results from the evaluation model using the corresponding features. The feature evaluation system may compare the performance metrics, and may rank the data sources based on the performance metrics. In some embodiments, the feature evaluation system may determine to modify the machine learning model based on the performance metrics and/or the ranking. For example, the feature evaluation system may select the data source having the best performance metrics, and may modify the machine learning model to incorporate the features from the selected data source.

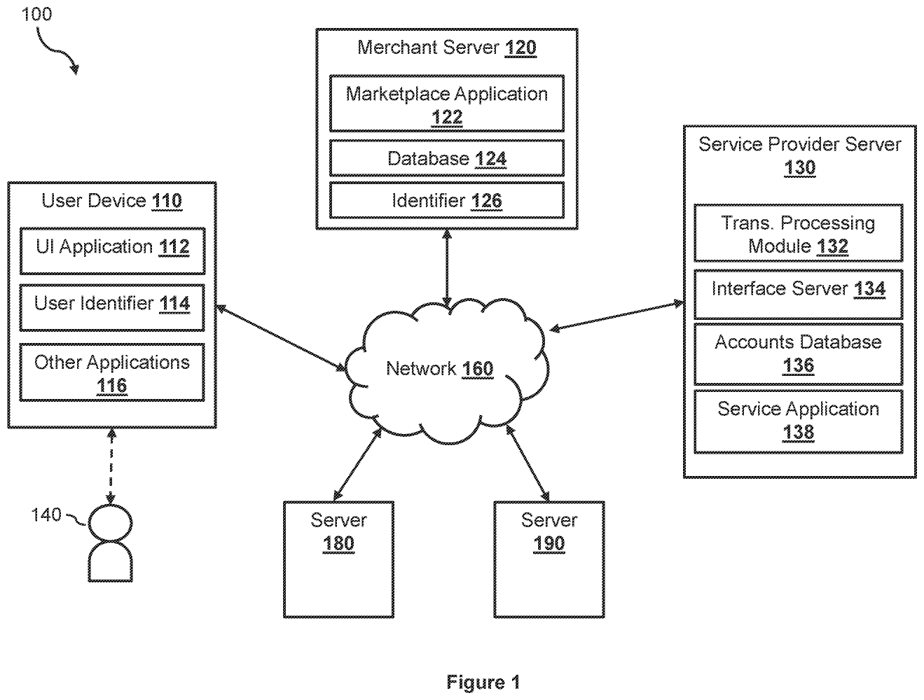

FIG. 1 illustrates an electronic transaction system 100, within which the computer modeling system may be implemented according to one embodiment of the disclosure. The electronic transaction system 100 includes a service provider server 130, a merchant server 120, a user device 110, and servers 180 and 190 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120 respectively. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to add a new funding account, to perform an electronic purchase with a merchant associated with the merchant server 120, to provide information associated with the new funding account, to initiate an electronic payment transaction with the service provider server 130, to apply for a financial product through the service provider server 130, to access data associated with the service provider server 130, etc.).

While only one user device 110 is shown in FIG. 1, it has been contemplated that multiple user devices, each associated with a different user, may be connected to the merchant server 120 and the service provider server 130 via the network 160.

The merchant server 120, in various embodiments, may be maintained by a business entity (or in some cases, by a partner of a business entity that processes transactions on behalf of business entity). Examples of business entities include merchants, resource information providers, utility providers, real estate management providers, social networking platforms, etc., which offer various items for purchase and process payments for the purchases. The merchant server 120 may include a merchant database 124 for identifying available items or services, which may be made available to the user device 110 for viewing and purchase by the user.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing for electronic transactions between the user 140 of user device 110 and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140 or a merchant associated with the merchant server 120, etc.) may access a user account associated with the user and access various services offered by the service provider server 130, by generating HTTP requests directed at the service provider server 130.

The service provider server 130, in one embodiment, may be configured to maintain one or more user accounts and merchant accounts in an accounts database 136, each of which may be associated with a profile and may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a transaction processing module 132 that implements the feature evaluation system as discussed herein. The transaction processing module 132 may be configured to process transaction requests received from the user device 110 and/or the merchant server 120 via the interface server 134. In some embodiments, depending on the type of transaction requests received via the interface server 134 (e.g., a login transaction, a data access transaction, a payment transaction, etc.), the transaction processing module 132 may use different machine learning models (e.g., transaction models) to perform different tasks associated with the transaction request. For example, the transaction processing module 132 may use various machine learning models to analyze different aspects of the transaction request (e.g., a fraudulent transaction risk, a chargeback risk, a recommendation based on the request, etc.). The machine learning models may produce outputs that indicate a risk (e.g., a fraudulent transaction risk, a chargeback risk, a credit risk, etc.) or indicate an identity of a product or service to be recommended to a user. The transaction processing module 132 may then perform an action for the transaction request based on the outputs. For example, the transaction processing module 132 may determine to authorize the transaction request (e.g., by using the service applications 138 to process a payment transaction, enabling a user to access a user account, etc.) when the risk is below a threshold, and may deny the transaction request when the risk is above the threshold.

In some embodiments, to perform the various tasks associated with the transaction request (e.g., assess a fraudulent risk of the transaction request, assessing a chargeback risk, generating a recommendation, etc.), the machine learning models may use attributes related to the transaction request, the user who initiated the request, the user account through which the transaction request is initiated, a merchant associated with the request, and other attributes during the evaluation process to produce the outputs. In some embodiments, the transaction processing module 132 may obtain the attributes for processing the transaction requests from different sources. For example, the transaction processing module 132 may obtain, from an internal data sources (e.g., the accounts database 136, the interface server 134, etc.), attributes such as device attributes of the user device 110 (e.g., a device identifier, a network address, a location of the user device 110, etc.), attributes of the user 140 (e.g., a transaction history of the user 140, a demographic of the user 140, an income level of the user 140, a risk profile of the user 140, etc.), attributes of the transaction (e.g., an amount of the transaction, etc.). The transaction processing module 132 may also obtain other attributes from one or more external data sources (e.g., servers 180 and 190).

Each of the servers 180 and 190 may be associated with a data analytics organization (e.g., a company analytics organization, a web analytics organization, etc.) configured to provide data associated with different companies and/or websites. The servers 180 and 190 may be third-party servers that are not affiliated with the service provider server 130. In some embodiments, the service provider associated with the service provider server may enter into an agreement (e.g., by paying a fee such as a one-time fee or a subscription fee, etc.) with the data analytics organizations to obtain data from the servers 180 and 190. As such, the transaction processing module 132 may obtain additional attributes related to the transaction request from the servers 180 and 190 for processing the transaction request. For example, the transaction processing module 132 may obtain, from the server 180, attributes such as a credit score of the merchant associated with the transaction request, a size of the merchant, an annual income of the merchant, etc. The transaction processing module 132 may also obtain, from the server 190, attributes such as a hit-per-day metric for a merchant website of the merchant, a session duration metric for the merchant website, etc.

Upon obtaining the attributes from the internal data source and the external data sources, the transaction processing module 132 may use one or more machine learning models to perform tasks related to the processing of the transaction request based on the attributes.

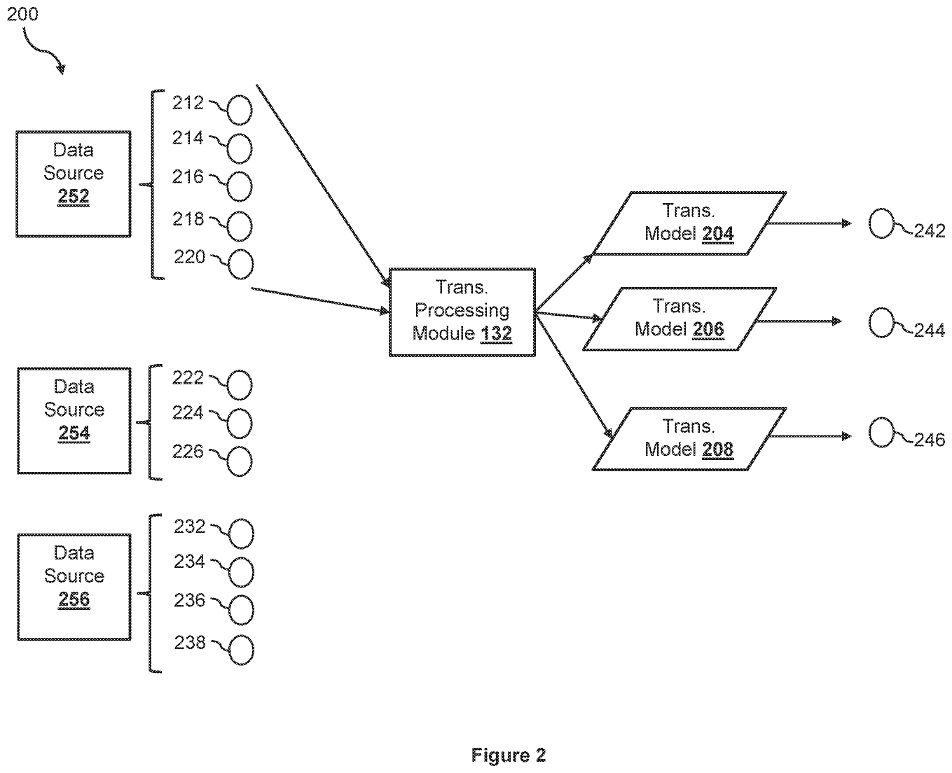

FIG. 2 is a diagram 200 illustrating various machine learning models (e.g., transaction models 204, 206, and 208) that may be used by the transaction processing module 132 to perform various tasks related to processing transactions for the service provider server 130 according to various embodiments of the disclosure. For example, the transaction processing module 132 may use the transaction model 204 to determine a fraudulent transaction risk associated with the transaction request based on the obtained attributes. The transaction processing module 132 may also use the transaction model 206 to determine a chargeback risk associated with the transaction request based on the obtained attributes. The transaction processing module 132 may also use the transaction model 246 to determine a recommendation (e.g., a product or service recommendation) for the user 140 based on the obtained attributes.

In some embodiments, each of the transaction models 204, 206, 208 may be implemented using a complex machine learning model structure, such as various types of artificial neural networks. The transaction processing module 132 may configure each of the transaction models 204, 206, and 208 to accept features 212, 214, 216, 218, and 220 from the data source 252 as input features for performing the respective tasks. In this example, the data source 252 may encompass one or more data sources, which may include an internal data source and/or an external data source. Each of the transaction models 204, 206, and 208 may be configured to produce an output based on the features 212, 214, 216, 218, and 220. For example, the transaction model 204 may produce an output 242 (e.g., a risk score) that indicates a likelihood that the transaction is associated with a fraudulent transaction. The transaction model 206 may produce an output 244 (e.g., a risk score) that indicates a likelihood that a chargeback request may be received in association with the transaction in the future. The transaction model 208 may produce an output 246 (e.g., a risk score) that indicates an identity of a produce/service to be recommended to a user based on the transaction.

The transaction processing module 132 may process the transaction request based on the outputs from the transaction models 204, 206, and 208. For example, the transaction processing module 132 may authorize the transaction request when the fraudulent transaction risk and the chargeback risk are below a threshold, but may deny the transaction request when either of the fraudulent transaction risk or the chargeback risk is above the threshold. The transaction processing module 132 may also present a product or service recommendation as the transaction request is processed.

As discussed herein, after configuring and training the transaction models, additional features that may be relevant in performing the tasks may become accessible by the service provider server 130. For example, new data sources (e.g., data sources 254 and 256) that provide data associated with web analytics may become available to the service provider server 130. In this example, the data source 254 may offer features 222, 224, and 226, and the data source 256 may offer features 232, 234, 236, and 238. The features 222, 224, 226, 232, 234, 236, and 238 offered by the data sources 254 and 256 may be relevant in performing the tasks associated with the transaction models 204, 206, and 208. As such, the service provider server 130 may consider incorporating one or more of these features into the transaction models 204 ,206, and 208. However, incorporating new features into the transaction models 204, 206, and 208 can require a substantial amount of computer resources and can also take a substantial amount of time. For example, the internal machine learning model structure of the transaction models 204, 206, and 208 may have to be modified, and the modified transaction models have to be re-trained using new training data. Furthermore, the access to the features 222, 224, 226, 232, 234, 236, and 238 offered by the data sources 254 and 256 may also be associated with a cost (e.g., a subscription fee or a one-time fee to one or more third-party providers). As such, it is desirable to evaluate the benefits of the new features 222, 224, 226, 232, 234, 236, and 238 offered by the data sources 254 and 256 before committing to the cost and resources for incorporating the new features into the transaction models 204, 206, and 208.

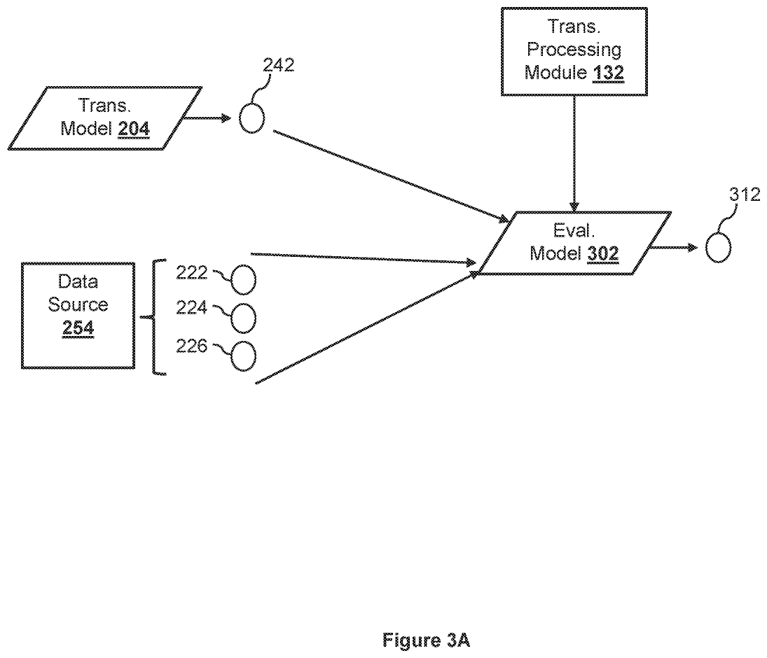

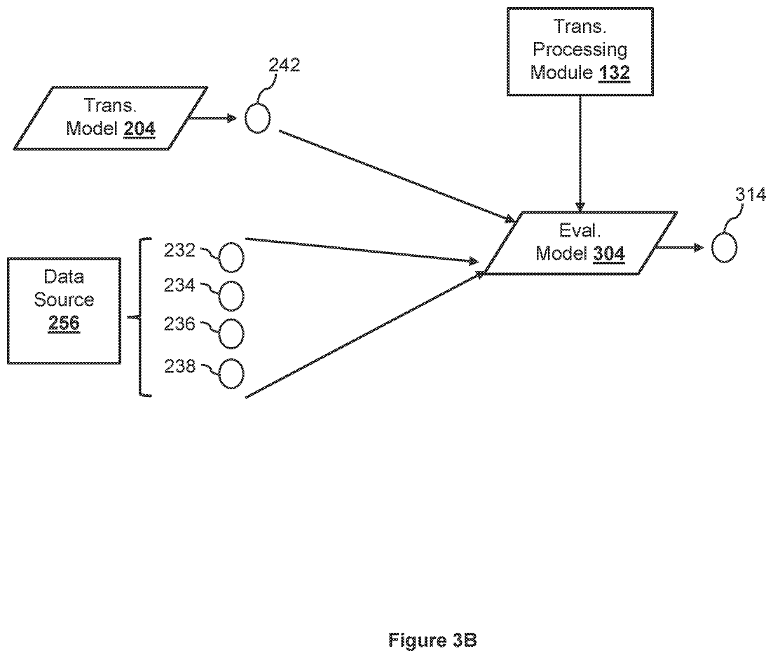

FIG. 3A illustrates an example evaluation model for evaluating effects of one or more features in performing a task associated with a machine learning model according to various embodiments of the disclosure. As shown, the transaction processing module 132 may generate an evaluation module 302 for evaluating the features 222, 224, and 226 from the data source 254. In some embodiments, the transaction processing module 132 may implement the evaluation model 302 using a machine learning model structure that is simpler than the one used to implement the transaction models 204, 206, and 208. For example, when the transaction models 204, 206, and 208 are implemented using a type of artificial neural network, the evaluation model 302 may be implemented using a gradient boosting tree. While complex machine learning models (e.g., an artificial neural network) provide a higher level of accuracy performance in performing the task due to their advanced and complex internal structures for analyzing data, the simpler machine learning models (e.g., gradient boosting trees) provide simpler and faster implementation and training, which improves the speed for evaluating the new features.

In some embodiments, the transaction processing module 132 may configure the evaluation model 302 to accept (i) the output 242 from the transaction model 204 and (ii) the features 222, 224, and 226 from the data source 254 as input features to perform the task associated with the transaction model 204. Thus, the evaluation model 302 may be configured to produce an output 312 (e.g., a risk score) that indicates a likelihood that a transaction is associated with a fraudulent transaction based on the features 242, 222, 224, and 226.

The transaction processing module 132 may generate training data for training the evaluation model 302. Each training data set may include values that correspond to the feature 242 (e.g., an actual output from the transaction model 204 based on data corresponding to the set of features 212, 214, 216, 218, and 220 and associated with a transaction), and values that correspond to the features 222, 224, and 226 (e.g., actual attributes associated with the transaction provided by the data source 254). For example, the service provider server 130 may have access to the data source 254 for a short duration (e.g., as a trial period) before the service provider server 130 has to make a decision to commit to obtaining data from the data source 254. The trial last for a few hours to a few days, which may give the service provider a chance to obtain some data attributes corresponding to the features 222 ,224, and 226 and associated with real-life transactions, but not long enough for the service provider server 130 to modify the transaction model 204 to incorporate the new features 222, 224, and 226. During the trial period, the transaction processing module 132 may obtain transaction data sets from the accounts database 136. Each transaction data set is associated with a previously processed transaction and may include data attributes corresponding to features 212, 214, 216, 218, and 220 from the data source 252, an output value corresponding to the output 242 that the transaction model 204 generates based on the data attributes corresponding to the features 212, 214, 216, 218, and 220, and a label that indicates the actual outcome from processing the corresponding to transaction.

Consider an example where the machine learning model 204 is configured to determine a risk that the transaction is associated with a fraudulent transaction. After processing each transaction, the transaction processing module 132 may determine an actual outcome which indicates whether the transaction has turned out to be a fraudulent transaction or a legitimate transaction. The actual outcome may be stored as a label in the transaction data set. In some embodiments, the transaction processing module 132 may generate a training data set for that transaction to include the output value corresponding to the output 242 generated by the transaction model 204 and the label.

In addition, for each transaction, the transaction processing module 132 may query the data source 254 for data attributes corresponding to the features 222, 224, and 226 and associated with the transaction. If the data source 254 provides analytics information associated with a merchant website, the transaction processing module 132 may obtain an identifier of a merchant website (e.g., a web address, etc.) through which the transaction was conducted. The transaction processing module 132 may query the data source 254 using the identifier, and may obtain analytics information (e.g., data attributes corresponding to the features 222, 224, and 226) associated with the merchant website from the data source 254. The transaction processing module 132 may then store the data attributes corresponding to the features 222, 224, and 226 in the corresponding training data set.

The transaction processing module 132 may train the evaluation model 302 using the generated training data set. By feeding the data corresponding to the features 242, 222, 224, 226 from the training data set to the evaluation model 302 to obtain an output and using the corresponding label to adjust the internal parameters of the evaluation model 302 (e.g., based on a loss function that minimizes the difference between the output of the evaluation model 302 and the label), the evaluation model 302 may be trained to learn patterns in association with performing the task (e.g., determining a risk that a transaction is associated with a fraudulent transaction, etc.).

After training the evaluation model 302, the transaction processing module 132 may begin evaluating the features 222, 224, and 226 from the data source 254 with respect to performing the task. In some embodiments, the transaction processing module 132 may generate testing data for evaluating the features 222, 224, and 226. For example, the transaction processing module 132 may generate the testing data in a similar manner as generating the training data using transaction data associated with a previously conducted transaction. In some embodiments, the transaction processing module 132 may generate testing data based on the processing of transactions in real-time. In particular, whenever the transaction processing module 132 processes an incoming transaction (e.g., an electronic payment transaction initiated via an interface provided by the interface server 134), the transaction processing module 132 may retrieve data attributes corresponding to the features 222, 224, and 226 and associated with the transaction from the data source 254, in addition to data attributes corresponding to the features 212, 214, 216, 218, and 220 and associated with the transaction from the data source 252. For example, based on information associated with the transaction (e.g., a website address via which the transaction was conducted, etc.), the transaction processing module 132 may query the data source 254 for data associated with a particular website.

The transaction processing module 132 may use the transaction model 204 to generate an output value corresponding to the output feature 242 for the transaction based on the data attributes corresponding to the features 212, 214, 216, 218, and 220. The output value may be used by the transaction processing module 132 to actually process the transaction (e.g., determining to authorize or deny the transaction, etc.). In order to evaluate the features 222, 224, and 226, the transaction processing module 132 may store the output value corresponding to the feature 242 along with the data attributes corresponding to the features 222, 224, and 226 retrieved from the data source 254 as testing data for the evaluation model 302. When the actual outcome of the transaction is available to the transaction processing module 132, the transaction processing module 132 may add a label indicating the actual outcome of the transaction to the corresponding testing data set.

The transaction processing module 132 may then provide the testing data to the evaluation model 302 to evaluate the features 222, 224, and 226. Based on the data values corresponding to the features 242, 222, 224, and 226 in each testing data set, the evaluation model 302 may generate another output value corresponding to the output feature 312. The transaction processing module 132 may then assess the features 222, 224, and 226 based on the output value corresponding to the output feature 312. For example, the transaction processing module 132 may determine one or more performance metrics associated with the performance of the evaluation model 302 by comparing the output values generated by the evaluation model 304 against the labels in the testing data. The performance metrics may include a false positive rate (i.e., indicating a percentage of the transactions that are falsely determined to be fraudulent using the evaluation model 302), a false negative rate (i.e., indicating a percentage of the transactions that are falsely determined to be legitimate using the evaluation model 302), and/or a catch count (e.g., a number of transactions that are determined to be fraudulent while maintaining a predetermined false positive rate and/or a predetermined false negative rate).

In some embodiments, the transaction processing module 132 may also determine performance metrics for the transaction model 204. For example, the transaction processing module 132 may compare the output values generated by the transaction model 204 against the labels in the testing data. The transaction processing module 132 may then compare the performance metrics of the evaluation model 302 against the performance metrics of the transaction model 204 to determine a performance improvement based on the features 222, 224, and 226. For example, the transaction processing module 132 may determine that the features 222, 224, and 226 provide a 5% improvement in false positive rate based on a difference between the false positive rate of the evaluation model 302 and the false positive rate of the transaction model 204. The transaction processing module 132 may determine that the features 222, 224, and 226 provide a 7% improvement in false negative rate based on a difference between the false negative rate of the evaluation model 302 and the false negative rate of the transaction model 204. The transaction processing module 132 may determine that the features 222, 224, and 226 provide a 3% recall lift based on a difference between the catch count of the evaluation model 302 and the catch count of the transaction model 204, when both of the evaluation model 302 and the transaction model 204 have the same false positive rate and/or the same false negative rate.

The transaction processing module 132 may then determine whether to incorporate the features 222, 224, and 226 into the transaction model 204 based on the performance improvements of the evaluation model 302 over the transaction model 204. For example, the transaction processing module 132 may determine a set of performance improvement benchmarks (e.g., a particular improvement in the false positive rate, a particular improvement in the false negative rate, a particular improvement in the catch count, etc.) and may determine to incorporate the features 222, 224, and 226 into the transaction model 204 when the performance improvements associated with the evaluation model 302 meet or exceed the performance improvement benchmarks. In some embodiments, the transaction processing module 132 may use one or more feature selection algorithms (e.g., using an XGBoost feature importance algorithm to compute SHAP values across the features, etc.). If the performance improvements of the evaluation model 302 meet or exceed the benchmark, the transaction processing module 132 may modify the transaction model 204 by using the features 212, 214, 216, 218, 220, as well as the features 222, 224, and 226 from the data source 254 as input features for performing the task. If the performance improvements of the evaluation model 302 do not meet the benchmark, the transaction processing module 132 may decline to incorporate the features 222, 224, and 226 into the transaction model 204, and may not accept to use the services provided by the data source 254.

When other new features become available to the service provider server 130 (e.g., a new data source such as the data source 256) for performing the task associated with the machine learning model 204, the transaction processing module 132 may evaluate the features of the new data source (e.g., the features 232, 234, 236, and 238 of the data source 256) using the same techniques as disclosed herein.

For example, as shown in FIG. 3B, the transaction processing module 132 may generate an evaluation model 304 for evaluating the features 232, 234, 236, and 238 from the data source 256. The transaction processing module 132 may configure the evaluation model 304 to accept input values corresponding to an output 242 of the transaction model 204 and the features 232, 234, 236, and 238 from the data source 256. The transaction processing module 132 may then generate training data for the evaluation model 304 and train the evaluation model 304 with the training data. The transaction processing module 132 may also generate testing data for evaluating the features 232, 234, 236, and 238 in a similar manner as evaluating the features 222, 224, and 226 using the evaluation model 302. The transaction processing module 132 may then determine whether to incorporate the features 232, 234, 236, and 238 into the transaction model 204 based on the performance improvements of the evaluation model 304 over the transaction model 204.

In certain situations, multiple data sources that provide data in the same field may become available to the service provider server 130. For example, both of the data sources 254 and 256 may provide analytics data associated with different websites. Though, the data sources 254 and 256 may provide different types of data or data in different formats that are related to website analytics. For example, the data source 254 may provide data such as an average number of daily hits on a website while the data source 256 may provide data such as an average session duration from visitors to a website. In these situations, the service provider server 130 may need to choose which data source to obtain additional data from, for performing the task. However, due to the different data types that are offered by each of the data sources 254 and 256, it can be challenging to compare between the features 222, 224, and 226 of the data source 254 and the features 232, 234, 236, and 238 of the data source 256.

According to various embodiments of the disclosure, the transaction processing module 132 may use the techniques disclosed herein to compare the effects of the different sets of features for performing the task. For example, by using the evaluation models 302 and 304, the transaction processing module 132 may determine the performance metrics associated with the respective evaluation models 302 and 304 in performing the task, which may include a false positive rate, a false negative rate, a catch count, etc. The transaction processing module 132 may then compare the performance metrics associated with the two evaluation models 302 and 304 to determine which set of features provide better performance in performing the task, and how much improvements each evaluation model has over the existing transaction model 204.

In some embodiments, to eliminate the possibility that the different internal structures of the evaluation models 302 and 304 (e.g., due to the different numbers and/or different types of input features for the two models) affects the performance evaluations, the transaction processing module 132 may normalize the different features by encoding both sets of features into the same space before providing the encoded inputs to the respective models 302 and 304.

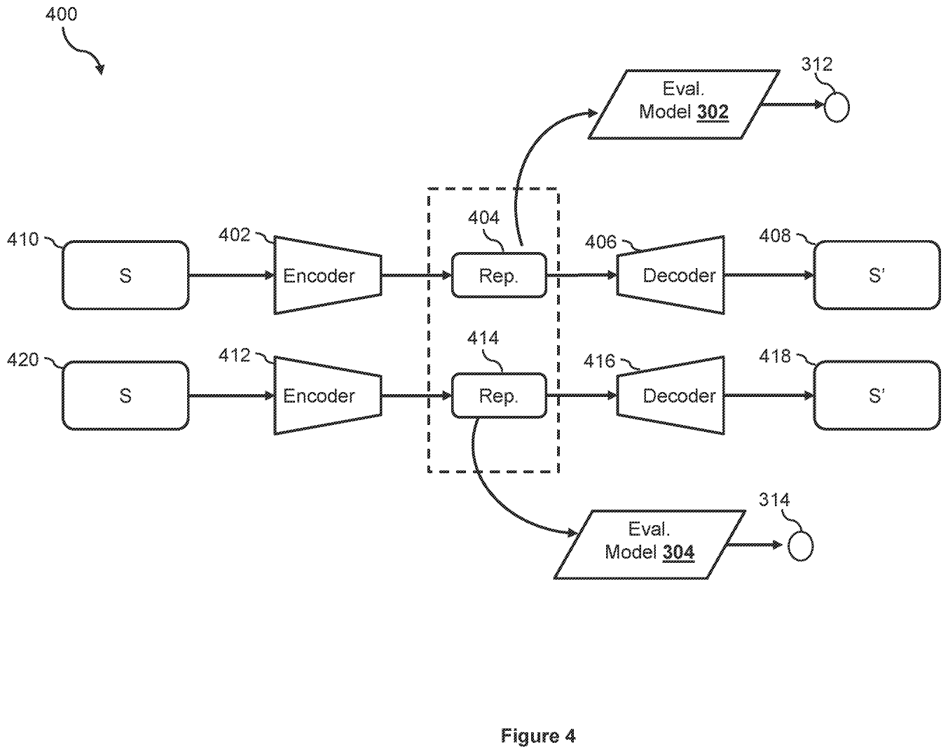

FIG. 4 is a diagram 400 illustrating the encoding of features from different data sources according to various embodiments of the disclosure. As shown in the figure, the transaction processing module 132 may generate an encoder for each of the data sources 254 and 256. In this example, the transaction processing module 132 may generate an encoder 402 for encoding a feature set 410 (which may include the features 222, 224, and 226 of the data source 254), and may generate an encoder 412 for encoding another feature set 420 (which may include the features 232, 234, 236, and 238 of the data source 256).

Each of the encoders 402 and 412 may be configured to encode the respective feature sets 410 and 420 into respective sets of representations 404 and 414 within the same multi-dimensional space. For example, the encoder 402 may be configured to encode the features 222, 224, and 226 into a set of representations 404. The set of representations 404 may include the same or different number of values than the features 222, 224, and 226 of the data source 254, but accurately represent the values corresponding to the features 222, 224, and 226. Similarly, the encoder 412 may be configured to encode the features 232, 234, 236, and 238 into a set of representations 414. The set of representations 414 may include the same or different number of values than the features 232, 234, 236, and 238 of the data source 256, but accurately represent the values corresponding to the features 232, 234, 236, and 238. Each of the sets of representations 412 and 414 may include the same number of representations. In some embodiments, each of the sets of representations 412 and 414 may be represented as a vector within the multi-dimensional space. In some embodiments, in order to ensure that the set of representations 404 and 414 accurately represents the respective features set, the transaction processing module 132 may generate decoders 406 and 416 for the corresponding encoders 402 and 412, respectively. Each of the decoders 406 and 416 is configured to expand the respective representations 404 and 414 to respective feature sets 408 and 418. By training the encoder 402 and the decoder 406 together based on a goal of minimizing the difference between the feature set 410 from the data source 254 and the decoded feature set 408, the encoder 402 can be trained to produce representations 404 that accurately represent the feature set 410. Similarly, by training the encoder 412 and the decoder 416 together based on a goal of minimizing the difference between the feature set 420 from the data source 256 and the decoded feature set 418, the encoder 412 can be trained to produce representations 414 that accurately represent the feature set 420.

The transaction processing module 132 may configure the evaluation models 302 and 304 to accept an output from the transaction model 204 and a vector from the multi-dimensional space (e.g., representations 404 and 414) as input features for performing the task. This way, the different data types associated with the different feature sets from the data sources 254 and 256 can be normalized and compared directly. The evaluation models 302 and 304 that are configured to accept the representations 404 and 406 may be trained and evaluated using the same techniques as disclosed herein. The transaction processing module 132 may compare the performance metrics associated with the evaluation models 302 and 304 to determine which has better performance improvements over the machine learning model 204.

In some embodiments, the transaction processing module 132 may perform the same evaluation process on different features (from different data sources). In addition, the transaction processing module 132 may evaluate the effect of different features on performing different tasks associated with different underlying machine learning models (e.g., the transaction models 206 and 208) using the same techniques. Such an evaluation may assist the transaction processing module 132 in determining whether and how to modify the machine learning models to further improve the performance of these machine learning models.

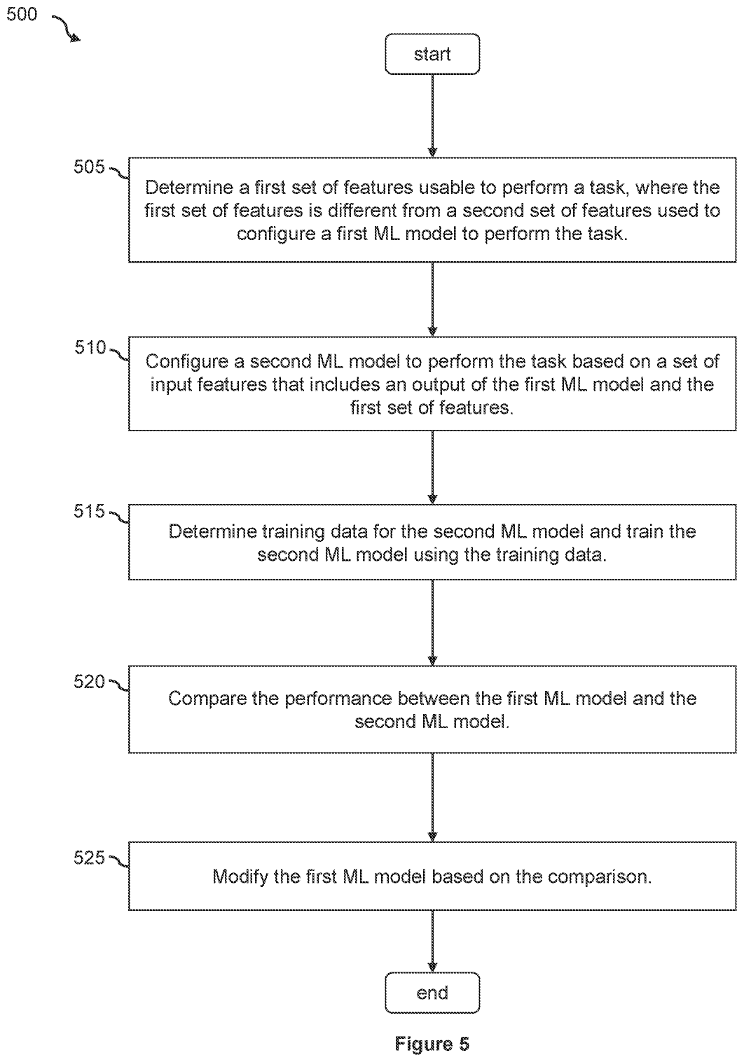

FIG. 5 illustrates a process 500 for evaluating a set of features usable for a machine learning model to perform a task according to various embodiments of the disclosure. In some embodiments, at least a portion of the process 500 may be performed by the transaction processing module 132. The process 500 begins by determining (at step 505) a first set of features usable to perform a task, wherein the first set of features is different from a second set of features used to configure a first machine learning model to perform the task. For example, the transaction processing module 132 may include one or more machine learning models (e.g., the transaction models 204, 206, and 208) for performing various tasks related to processing electronic transactions for the service provider server 130. Each of the transaction models 204, 206, and 208 may be configured to accept a set of input features for performing the corresponding task. The transaction model 204 may be configured to use the features 212, 214, 216, 218, and 220 from the data source 252 to determine if a transaction is associated with a fraudulent transaction. After configuring and training the transaction model 204, the transaction processing module 132 may determine that a set of features (e.g., the features 222, 224, and 226 from the data source 254) has become available to the service provider server 130 for performing the task associated with the transaction model 204.

The process 500 then configures (at step 510) a second machine learning model to perform the task based on a set of input features that includes an output of the first machine learning model and the first set of features. As discussed herein, modifying a machine learning model to incorporate new features for performing a task can consume a substantial amount of resources (e.g., computing resources for configuring and training the modified model, time to train the modified model, etc.) of the service provider server 130. Furthermore, the right to access the new features usually comes with a cost. As such, it may be desirable to evaluate the effect of the new features (e.g., how much gain in performance for performing the task with the addition of the new features, etc.) before committing to incorporating the new features. As such, the transaction processing module 132 may generate the evaluation model 302 for evaluating the features 222, 224, and 226. In some embodiments, the transaction processing module 132 may configure the evaluation model 302 to accept inputs corresponding to the output from the transaction model 204 and the new features (e.g., the features 222, 224, and 226 from the data source 254) for performing the task associated with the transaction model 204.

The process 500 determines (at step 515) training data for the second machine learning model and trains the second machine learning model using the training data. For example, the transaction processing module 132 may determine training data for the evaluation model 302 based on previous transactions that have been processed by the transaction processing module 132. In some embodiments, the transaction processing module 132 may obtain transaction data from the accounts database 136. The transaction data may include data attributes corresponding to the features 212, 214, 216, 218, and 220 used by the transaction model 204 for performing the task related to processing the transaction. The transaction data may also include an output value generated by the transaction model 204 based on the data attributes corresponding to the features 212, 214, 216, 218, and 220. The output value may also include an indication of an actual outcome from processing the transaction and related to the task performed by the transaction model 204. For example, if the transaction model 204 is configured to determine a likelihood that the transaction is associated with a fraudulent transaction, the actual outcome may indicate whether the transaction is a fraudulent transaction or a legitimate transaction. Thus, the transaction processing module 132 may include the output value from the transaction model 204 and the actual outcome in a corresponding training data record. In some embodiments, the transaction processing module 132 may also retrieve, for the transaction, data corresponding to the features 222, 224, and 226 from the data source 254, and include the retrieved data in the corresponding training data record. The transaction processing module 132 may then train the evaluation model 302 using the training data records.

The process 500 then compares (at step 520) the performance between the first machine learning model and the second machine learning model, and modifies (at step 525) the first machine learning model based on the comparison. For example, the transaction processing module 132 may evaluate the performance of the evaluation model 302. Since the evaluation model 302 uses the existing transaction model (e.g., the transaction model 204) and the new features (e.g., the features 222, 224, and 226) for performing the task, the performance of the evaluation model 302 in performing the task (e.g., how accurate does the evaluation model 302 predicts an outcome of the transaction, etc.) may estimate the actual performance of a hypothetical machine learning model that uses the new features 222, 224, and 226 along with the existing features 212, 214, 216, 218, and 220 for performing the task. Thus, the transaction processing module 132 may determine performance metrics for the evaluation model 302, which indicates the performance of the inclusion of the new features 222, 224, and 226 for performing the task. The performance metrics may include a false positive rate, a false negative rate, and/or a catch count.

In some embodiments, the transaction processing module 132 may also determine performance metrics for the transaction model 204, which uses only the features 212, 214, 216, 218, and 220 for performing the task. By comparing the performance metrics between the evaluation model 302 and the transaction model 204, the transaction processing module 132 may determine an estimated performance improvements based on the inclusion of the features 222, 224, and 226. In some embodiments, the transaction processing module 132 may determine to modify the transaction model 204 to incorporate the features 222, 224, and 226 when the performance improvements exceed a benchmark improvement.

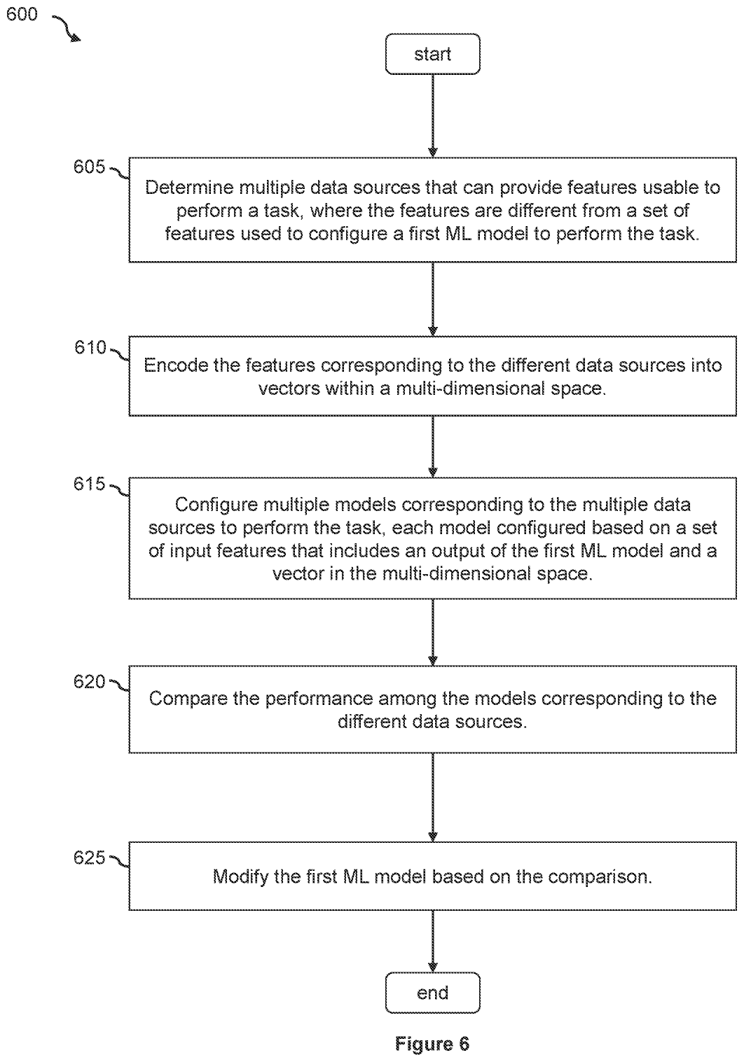

FIG. 6 illustrates a process 600 for comparing performance associated with using two different sets of features for performing a task according to various embodiments of the disclosure. In some embodiments, at least a portion of the process 600 may be performed by the transaction processing module 132. The process 600 begins by determining (at step 605) multiple data sources that can provide features usable to perform a task, where the features are different from a set of features used to configure a first machine learning model to perform the task. For example, after configuring and training the transaction model 204 to perform a task related to processing transactions (e.g., determining whether a transaction is associated with a fraudulent transaction, etc.) using a set of input features (e.g., the features 212, 214, 216, 218, and 220), the transaction processing module 132 may determine that features from different data sources (e.g., the data sources 254 and 256) that are usable to perform the task may become available to the service provider server 130. The features from the different data sources 254 and 256 may be related to the same area (e.g., website analytics, etc.), but may include different data types and/or in different data formats. As such, in order to perform the comparison more accurately, the transaction processing module 132 may normalize the features from the different data sources 254.

The process 600 then encodes (at step 610) the features corresponding to the different data sources into vectors within a multi-dimensional space. For example, the transaction processing module 132 may generate an encoder for each of the data sources 254 and 256. Each of the encoders may be configured to encode the respective features into a set of representations of the features within a multi-dimensional space. The encoder 402 may be configured to encode the features 222, 224, and 226 from the data source 254 into a set of representations 404, while the encoder 412 may be configured to encode the features 232, 234, 236, and 238 into a set of representations 414. Since the representations 412 and 414 are within the same multi-dimensional space, the representations 412 and 414 can be compared against each other more accurately.

The process 600 configures (at step 615) multiple models corresponding to the multiple data sources to perform the task, each model configured based on a set of input features that includes an output of the first machine learning model and a vector in the multi-dimensional space. For example, the transaction processing module 132 may configure each of the evaluation models 302 and 304 to accept input data corresponding to an output of the transaction mode 204 and a representation (e.g., the representations 404 and/or 414) within a multi-dimensional space.

The process 600 then compares (at step 620) the performance among the models corresponding to the different data sources and modifies (at step 625) the first machine learning model based on the comparison. For example, the transaction processing module 132 may train the evaluation models 302 and 304, and evaluate the performance of the evaluation models 302 and 304 using techniques disclosed herein. The transaction processing module 132 may then compare the performance for performing the task between the evaluation models 302 and 304. In some embodiments, the transaction processing module 132 may determine performance metrics for each of the evaluation models 302 and 304. Based on the comparison, the transaction processing module 132 may select which features (e.g., which data source) to incorporate into the transaction model 204 for improving the performance of the transaction model 204. The transaction processing module 132 may then modify the transaction model 204 by incorporating the selected features as additional input features for the transaction model 204.

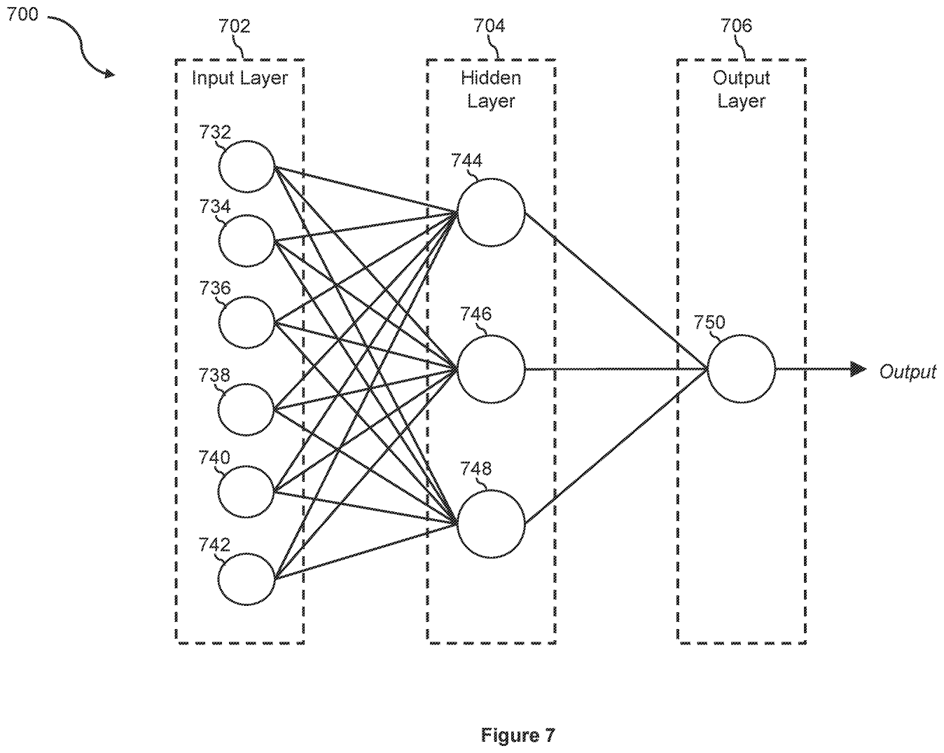

FIG. 7 illustrates an example artificial neural network 700 that may be used to implement any machine learning models (e.g., the transaction models 204, 206, and 208, the evaluation models 302 and 304, and the encoders 402 and 412, etc.). As shown, the artificial neural network 700 includes three layers—an input layer 702, a hidden layer 704, and an output layer 706. Each of the layers 702, 704, and 706 may include one or more nodes. For example, the input layer 702 includes nodes 732, 734, 736, 738, 740, and 742, the hidden layer 704 includes nodes 744, 746, and 748, and the output layer 706 includes a node 750. In this example, each node in a layer is connected to every node in an adjacent layer. For example, the node 732 in the input layer 702 is connected to all of the nodes 744, 746, and 748 in the hidden layer 704. Similarly, the node 744 in the hidden layer is connected to all of the nodes 732, 734, 736, 738, 740, and 742 in the input layer 702 and the node 750 in the output layer 706. Although only one hidden layer is shown for the artificial neural network 700, it has been contemplated that the artificial neural network 700 used to implement any one of the computer-based models may include as many hidden layers as necessary.

In this example, the artificial neural network 700 receives a set of inputs and produces an output. Each node in the input layer 702 may correspond to a distinct input. For example, when the artificial neural network 700 is used to implement a transaction model (e.g., the transaction models 204, 206, and 208), each node in the input layer 702 may correspond to an input feature (e.g., features 212, 214, 216, 218, and 220). When the artificial neural network 700 is used to implement an evaluation model (e.g., the evaluation model 302 and 304), each node in the input layer 702 may correspond to an input feature (e.g., an output from the corresponding machine learning model, new features, or a set of representations of the new features). When the artificial neural network 700 is used to implement an encoder (e.g., the encoders 402 and 404), each node in the input layer 702 may correspond to one of the new features from a corresponding data source. When the artificial neural network 700 is used to implement a decoder (e.g., the decoders 406 and 416), each node in the input layer 702 may correspond to a representation in the set of representations.

In some embodiments, each of the nodes 744, 746, and 748 in the hidden layer 704 generates a representation, which may include a mathematical computation (or algorithm) that produces a value based on the input values received from the nodes 732, 734, 736, 738, 740, and 742. The mathematical computation may include assigning different weights (e.g., node weights, etc.) to each of the data values received from the nodes 732, 734, 736, 738, 740, and 742. The nodes 744, 746, and 748 may include different algorithms and/or different weights assigned to the data variables from the nodes 732, 734, 736, 738, 740, and 742 such that each of the nodes 744, 746, and 748 may produce a different value based on the same input values received from the nodes 732, 734, 736, 738, 740, and 742. In some embodiments, the weights that are initially assigned to the input values for each of the nodes 744, 746, and 748 may be randomly generated (e.g., using a computer randomizer). The values generated by the nodes 744, 746, and 748 may be used by the node 750 in the output layer 706 to produce an output value for the artificial neural network 700. When the artificial neural network 700 is used to implement a transaction model or an evaluation model (e.g., the transaction models 204, 206, and 208 or the evaluation models 302 and 304) configured to produce an output associated with a transaction request, the output value produced by the artificial neural network 700 may indicate a risk (e.g., a risk score) or an identifier or a product, or any other types of indications related to the transaction request. When the artificial neural network 700 is used to implement one of the encoders 402 and 412 configured to reduce the set of input features into a set of representations of the input features, the output value(s) produced by the artificial neural network 700 may include the set of representations of the input features. When the artificial neural network 700 is used to implement one of the decoders 406 and 416 configured to expand a set of representations back to the input features, the output value(s) produced by the artificial neural network 700 may include the set of input features.

The artificial neural network 700 may be trained by using training data and one or more loss functions. By providing training data to the artificial neural network 700, the nodes 744, 746, and 748 in the hidden layer 704 may be trained (adjusted) based on the one or more loss functions such that an optimal output is produced in the output layer 706 to minimize the loss in the loss functions. By continuously providing different sets of training data, and penalizing the artificial neural network 700 when the output of the artificial neural network 700 is incorrect (as defined by the loss functions, etc.), the artificial neural network 700 (and specifically, the representations of the nodes in the hidden layer 704) may be trained (adjusted) to improve its performance in the respective tasks. Adjusting the artificial neural network 700 may include adjusting the weights associated with each node in the hidden layer 704.

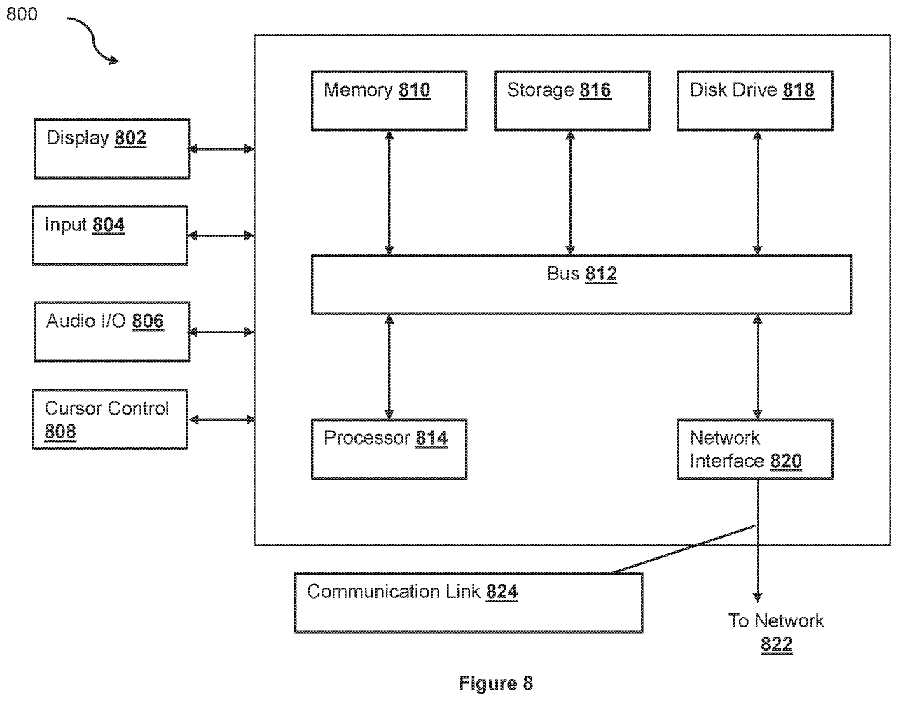

FIG. 8 is a block diagram of a computer system 800 suitable for implementing one or more embodiments of the present disclosure, including the service provider server 130, the merchant server 120, the user device 110, and the servers 180 and 190. In various implementations, the user device 110 may include a mobile cellular phone, personal computer (PC), laptop, wearable computing device, etc. adapted for wireless communication, and each of the service provider server 130, the merchant server 120, and the servers 180 and 190 may include a network computing device, such as a server. Thus, it should be appreciated that the devices 110, 120, 130, 180, and 190 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via a network 822. In one embodiment, the transmission is wireless, although other transmission mediums and methods may also be suitable. A processor 814, which can be a micro-controller, digital signal processor (DSP), or other processing component, processes these various signals, such as for display on the computer system 800 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the feature evaluation functionalities described herein, for example, according to the processes 500 and 600.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
determining a first set of features usable for performing a task, wherein the first set of features is different from a second set of features used to configure a first machine learning model for performing the task;
configuring a second machine learning model to perform the task based on a set of input features comprising an output of the first machine learning model and the first set of features;
determining a difference in prediction performance associated with the task between the first machine learning model and the second machine learning model; and
modifying the first machine learning model based on the difference.

2. The system of claim 1, wherein the operations further comprise:
generating training data sets for training the second machine learning model, wherein each of the training data sets comprises (i) data values corresponding to the output of the first machine learning model and the first set of features and (ii) a label indicating an actual result; and
training the second machine learning model using the training data sets.

3. The system of claim 1, wherein the determining the difference in prediction performance comprises:
determining a first false positive rate associated with the first machine learning model based on a set of testing data;
determining a second false positive rate associated with the second machine learning model based on the set of testing data; and
comparing the first false positive rate against the second false positive rate.

4. The system of claim 1, wherein the determining the difference in prediction performance comprises:
determining that the second machine learning model has a lower false negative rate than the first machine learning model.

5. The system of claim 1, wherein the modifying the first machine learning model comprises:
re-configuring the first machine learning model to perform the task based on a second set of input features comprising the first set of features and the second set of features.

6. The system of claim 1, wherein the operations further comprise:
determining a third set of features usable for performing the task, wherein the third set of features is different from the first set of features and the second set of features;
configuring a third machine learning model to perform the task based on a third set of input features comprising the output of the first machine learning model and the third set of features; and
determining a second difference in prediction performance between the second machine learning model and the third machine learning model, wherein the modifying the first machine learning model is further based on the second difference.

7. The system of claim 6, wherein the modifying the first machine learning model comprises:
determining that the third machine learning model has a higher accuracy performance than the second machine learning model; and
re-configuring the first machine learning model to perform the task based on a fourth set of input features comprising the second set of features and the third set of features.

8. A method, comprising:
determining, by one or more hardware processors, a first set of features usable for performing a task, wherein the first set of features is different from a second set of features used to configure a first machine learning model for performing the task;
generating, by the one or more hardware processors, a second machine learning model for evaluating the first set of features;
configuring, by the one or more hardware processors, the second machine learning model to perform the task based on a set of input features comprising an output of the first machine learning model and the first set of features;
determining, by the one or more hardware processors, a first performance improvement associated with the task of the second machine learning model over the first machine learning model; and
modifying, by the one or more hardware processors, the first machine learning model based on the first performance improvement.

9. The method of claim 8, further comprising:
determining a first set of performance metrics for the first machine learning model; and
determining a second set of performance metrics for the second machine learning model, wherein the first and second sets of performance metrics comprise at least one of a false positive rate, a false negative rate, or a catch count.

10. The method of claim 9, wherein the determining the first performance improvement comprises:
determining a difference between the first set of performance metrics and the second set of performance metrics.

11. The method of claim 8, further comprising:
determining that the first performance improvement exceeds a benchmark; and
in response to determining that the first performance improvement exceeds the benchmark, re-configuring the first machine learning model to perform the task based on a second set of input features comprising the first set of features and the second set of features.

12. The method of claim 8, further comprising:
determining a third set of features usable for performing the task, wherein the third set of features is different from the first set of features and the second set of features;
configuring a third machine learning model to perform the task based on a third set of input features comprising the output of the first machine learning model and the third set of features; and
determining a second performance improvement associated with the task of the third machine learning model over the first machine learning model, wherein the modifying the first machine learning model is further based on the second performance improvement.

13. The method of claim 12, wherein the modifying the first machine learning model comprises:
determining that the first performance improvement is greater than the second performance improvement; and
re-configuring the first machine learning model to perform the task based on a fourth set of input features comprising the first set of features and the second set of features.

14. The method of claim 12, further comprising:
encoding the first set of features and the third set of features into a common multi-dimensional space.

15. A non-transitory machine-readable medium having stored thereon machine-readable instructions executable to cause a machine to perform operations comprising:
determining a first set of features relevant in performing a prediction, wherein the first set of features is different from a second set of features used to configure a first machine learning model for performing the prediction;
configuring a second machine learning model to perform the prediction based on a set of input features comprising an output of the first machine learning model and the first set of features;
determining a difference in prediction performance between the first machine learning model and the second machine learning model; and
modifying the first machine learning model based on the difference.

16. The non-transitory machine-readable medium of claim 15, wherein the operations further comprise:
generating training data sets for training the second machine learning model, wherein each of the training data sets comprises (i) data values corresponding to the output of the first machine learning model and the first set of features and (ii) a label indicating an actual result corresponding to the prediction; and
training the second machine learning model using the training data sets.

17. The non-transitory machine-readable medium of claim 15, wherein the determining the difference in prediction performance comprises:
determining a first false positive rate associated with the first machine learning model based on a set of testing data;
determining a second false positive rate associated with the second machine learning model based on the set of testing data; and
comparing the first false positive rate against the second false positive rate.

18. The non-transitory machine-readable medium of claim 15, wherein the determining the difference in prediction performance comprises:
determining that the second machine learning model has a lower false negative rate than the first machine learning model.

19. The non-transitory machine-readable medium of claim 15, wherein the modifying the first machine learning model comprises:
re-configuring the first machine learning model to perform the prediction based on a second set of input features comprising the first set of features and the second set of features.

20. The non-transitory machine-readable medium of claim 15, wherein the operations further comprise:
determining a third set of features usable for performing the prediction, wherein the third set of features is different from the first set of features and the second set of features;
configuring a third machine learning model to perform the prediction based on a third set of input features comprising the output of the first machine learning model and the third set of features; and
determining a second difference in prediction performance between the second machine learning model and the third machine learning model, wherein the modifying the first machine learning model is further based on the second difference.
